(19) United States
(12) Patent Application Publication
(10) Pub. No.: US 2026/0134491 A1
(43) Pub. Date: May 14, 2026

(54) DIGITAL REAL ESTATE AGENT

(71) Applicant: Direct Offer, Inc., Nashville, TN (US)

(72) Inventor: Kathleen Lappe, Nashville, TN (US)

(73) Assignee: Direct Offer, Inc., Nashville, TN (US)

(21) Appl. No.: 19/052,156

(22) Filed: Feb. 12, 2025

Related U.S. Application Data
(60) Provisional application No. 63/719,742, filed on Nov. 13, 2024.

(51) Int. Cl. G06Q 50/16; G06Q 30/0601

(52) U.S. Cl. CPC G06Q 50/16; G06Q 30/0627; G06Q 30/0631

(57) ABSTRACT

Embodiments herein disclose a method and system for providing an interactive virtual tour of a real estate property. The method includes selecting the real estate property from a plurality of real estate properties by the first user. The method includes activating a conversation mode to enable an audio mode to explain a feature of the selected real estate property from the plurality of real estate properties. The method includes receiving a query from a first user about the selected real estate property from the plurality of real estate properties. Further, the method includes providing a response about the selected real estate property to the first user based on the query. The response elucidates a feature of the real estate property.

### CLAIM OF PRIORITY, IDENTIFICATION OF RELATED APPLICATIONS

This Non-Provisional patent application is a Continuation in Part of and claims priority from U.S. Non-Provisional patent application Ser. No. 17/968,780 filed on the 18 Oct. 2022 entitled “METHODS AND SYSTEMS FOR PROVIDING INTERACTIVE VIRTUAL TOUR OF REAL ESTATE PROPERTY” which is a Continuation of and claims priority from U.S. Non-Provisional patent application Ser. No. 16/939,762 filed on 27 Jul. 2020 entitled “systems and methods for selecting and displaying multimodal content”, to common inventor Kathleen A. Lappe.

### TECHNICAL FIELD

The present invention generally relates to a real estate management platform, and more specifically to methods and systems for providing an interactive virtual tour of real estate properties.

### PROBLEM STATEMENT AND HISTORY

### Interpretation Considerations

This section describes technical field in detail and discusses problems encountered in the technical field. Therefore, statements in the section are not to be construed as prior art.

### Discussion of History of the Problem

Common real estate platforms allow agents (aka “brokers”) and buyers to search, identify and even visit a property (e.g., land, building, flat, office space or the like). While these real estate platforms provide images and videos of the property, images and video can be misleading. After all, they do not provide minute details (aka “minor feature”) of the property, and the person recording the information—usually the seller or his agent—has every incentive to show positive property attributes and hide negative ones.

This sometimes results in disappointing buyer experiences. And, of course, if a potential buyer is interested in a property, they must visit the property verify details, which is time-consuming and can be expensive. In other words, audio and video as used by current platforms leads to distrust, rather than buyer confidence. There is presently no solution to these drawbacks. The present invention provides such a solution.

### SUMMARY

The above objective is achieved by systems and methods for providing an interactive virtual tour of a real estate property as defined in claims.

The method includes obtaining a first input associated with the real estate property from a first user to identify a real estate property from a plurality of real estate properties. The first input includes preference, historical transaction data, and market trend. Based on the first input, the method includes identifying and displaying the real estate property from the plurality of real estate properties using a data driven model. The method includes obtaining a second input associated with the real estate property from the first user to fine-tune listing of the real estate property obtained after the first input. The second input includes a property preference, budget constraint, and a location. Based on the second input, the method includes recommending and predicting the real estate property from the plurality of real estate properties using the data driven model. The method further includes receiving a third input to select the real estate property obtained after the second input. The method includes selecting the real estate property from the plurality of real estate properties by the first user. The method includes activating a conversation mode to enable an audio mode to explain a feature of the selected real estate property from the plurality of real estate properties. The method includes receiving a query from the first user about the selected real estate property from the plurality of real estate properties. Further, the method includes providing a response about the selected real estate property to the first user based on the query. The response elucidates a feature of the real estate property.

In an alternative implementation, the method includes analyzing a market trend, a historical listing, and a property feature associated with the real estate property from the plurality of real estate properties, over a period of time, to determine a valuation and marketing strategy for the real estate property from the plurality of real estate properties. The method further includes estimating a market value for the real estate property from the plurality of real estate properties by analyzing each comparable real estate property from the plurality of real estate properties, location-specific data, and property characteristics associated with the real estate property from the plurality of real estate properties. The method includes obtaining publicly available data including an image, a video, a map, a blueprint, historical pricing, population density, a crime rate, a square footage, a unique home feature, and a tax appraisal. The method includes generating a detailed property listing for the real estate property from the plurality of real estate properties based on the valuation and marketing strategy, the estimated market value and the publicly available data. The method includes obtaining a first input associated with the real estate property from a second user to display the real estate property from the plurality of real estate properties. The first input includes a listing preference, a desired price range, and a marketing goal. The method includes receiving a second input from the first user to select the real estate property from the plurality of real estate properties. The method includes activating a conversation mode to enable an audio mode to explain a feature of the selected real estate property based on the second input. The method includes receiving a query about the selected real estate property. The method includes providing a response about the selected real estate property based on the query. The response elucidates a feature of the real estate property.

In accordance with various embodiments of the present invention, the first user is a buyer and the second user is a seller.

Of course, the present is simply a Summary, and not a complete description of the invention.

### BRIEF DESCRIPTION OF THE DRAWINGS

Various aspects of the invention and its embodiment are better understood by referring to the following detailed description. To understand the invention, the detailed description should be read in conjunction with the drawings. The term “FIGURE” will be abbreviated as “FIG.” henceforth.

FIG. 1 illustrates a system for providing an interactive virtual tour of a real estate property.

FIG. 2 is a flow chart illustrating various acts (aka “interactive virtual tour algorithm”) to provide the interactive virtual tour of the real estate property.

FIG. 3 is a flow chart illustrating a trigger act in conjunction with FIG. 2.

FIG. 4 is a flow chart illustrating an authentication act in conjunction with FIG. 2.

FIG. 5 is a flow chart illustrating a display property card act in conjunction with FIG. 2.

FIG. 6 is a flow chart illustrating a virtual tour creation algorithm using a draft act and a presentation act in conjunction with FIG. 2.

FIG. 7 is a flow chart illustrating an edit act in conjunction with FIG. 2.

FIG. 8 is a flow chart illustrating a record act in conjunction with FIG. 2.

FIG. 9 is a flow chart illustrating an audio tour showcase act in conjunction with FIG. 2.

FIG. 10 is a flow chart illustrating a method for providing the interactive virtual tour of the real estate property.

FIG. 11 is a flow chart illustrating a method for providing the interactive virtual tour of the real estate property for a buyer.

FIG. 12 is a flow chart illustrating a method for providing the interactive virtual tour of the real estate property for a seller.

FIG. 13 is a screenshot showing an interactive virtual tour of a real estate property.

FIG. 14 is a screenshot depicting various features of the real estate property while providing the interactive virtual tour of the real estate property.

FIG. 15 is a screenshot depicting a feature associated with a kitchen while providing the interactive virtual tour of the real estate property.

FIG. 16 is a screenshot depicting a feature associated with a dining hall and a decorative element while providing the interactive virtual tour of the real estate property.

### DESCRIPTION OF AN EXEMPLARY PREFERRED EMBODIMENT

### Interpretation Considerations

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words such as “pressure heating”.

Unless explicitly stated otherwise, conjunctive words (such as “or”, “and”, “including”, or “comprising”) should be interpreted in the inclusive and not the exclusive sense.

As will be understood by those of the ordinary skill in the art, various structures and devices are depicted in the block diagram to not obscure the invention. In the following discussion, acts with similar names are performed in similar manners, unless otherwise stated.

The foregoing discussions and definitions are provided for clarification purposes and are not limiting. Words and phrases are to be accorded their ordinary, plain meaning, unless indicated otherwise.

### DESCRIPTION OF THE DRAWINGS, A PREFERRED EMBODIMENT

The present invention provides systems and methods using a set of algorithms which provides an interactive virtual tour of a real estate property to enhance the user experience and improve a mutually profitable success. The present invention is a data enrichment platform which combines a plurality of real estate properties to provide a knowledge to user(s) about the real estate property in an enhanced, cost and time effective manner.

The system leverages artificial intelligence (AI) model and machine learning (ML) model to support a buyer or a buyer's agent in efficiently navigating the real estate purchase process. It is designed to automate and optimize core functions traditionally performed by a human agent, improving accuracy, speed, and personalization in handling buyer-side activities and seller-side activities.

The system incorporates the AI model (or data driven model) to automate critical activities, from property selection to financing and negotiation, while enhancing user decision-making with interactive tools like the Offer Grid and real-time predictive insights. The AI continually learns and adapts to improve outcomes for buyers, streamlining the purchase process and providing personalized, data-driven support at every stage.

The system is a comprehensive AI-powered platform designed to assist sellers and their agents in optimizing the listing, marketing, and transaction processes for real estate(s). It leverages machine learning and predictive analytics to automate traditional seller-agent tasks, providing tailored insights and operational efficiencies that enhance the property sale process.

The system facilitates a streamlined real estate transaction workflow, enhancing operational efficiency and accessibility for both buyers and sellers. By integrating AI, the system is equipped to execute complex, time-sensitive functions, thereby providing users with a responsive, data-informed, and adaptive real estate experience.

For agents and sellers, the AI-powered system is configured to continuously source and qualify potential leads by employing predictive analytics. The system prioritizes leads according to transaction probability, thereby optimizing agent focus on high-potential clients.

Buyers often require property recommendations aligned with specific criteria, such as location, budget, and property features. The AI-driven system efficiently analyzes extensive property datasets alongside user preference profiles, generating recommendations that are precisely matched to client requirements, thus enhancing the buyer's experience by providing curated options.

The negotiation stage in real estate transactions requires complex, time-sensitive decision-making. The AI-driven system analyzes historical transaction data, predicts counteroffer responses, and suggests optimized negotiation strategies. This provides both buyers and sellers with immediate, data-based insights that inform negotiation choices, improving their competitive position.

The system empowers both buyers and sellers with real-time data insights, customized recommendations, and optimized transaction processes, thereby transforming traditional real estate activities into a more efficient, informed, and data-supported experience. The proposed method allows the seller and the buyer to bypass middle agents completely. By referencing local regulations and verifying completeness, the proposed system minimizes errors and ensures that documents comply with legal standards.

Below is the list of reference numerals used in the patent disclosure:

TABLE
List of reference numerals

| Reference | |
|---|---|
| Number | Element Name |
| 100 | System |
| 111 | One or more broker(s) |
| 112 | One or more owner(s) |
| 113 | One or more authorized person(s) |
| 120 | Website |
| 130 | Real estate module |
| 131 | Share block |
| 132 | Display |
| 133 | Communication block |
| 134 | Audio tour controller block |
| 135 | Account setting block |
| 136 | Subscription block |
| 140 | Load balancer |
| 145 | S3 bucket |
| 150 | Partner API Database |
| 155 | RDS instance Database |
| 160 | Cloud watch block |
| 171 | Broker user interface |
| 172 | Owner user interface |
| 173 | Authorized person user interface |
| 180 | Processor |
| 185 | Memory |
| 200 | Interactive virtual tour algorithm |
| 210 | Trigger act |
| 220 | Authentication act |
| 230 | Display property card act |
| 240 | Draft act |
| 250 | Presentation act |
| 260 | Edit act |
| 270 | Record act |
| 280 | Audio tour showcase act |
| 600 | Virtual tour creation algorithm |
| 1000 | Interactive virtual tour method |
| 1100 | Flow chart illustrating a method for providing the |
| | interactive virtual tour of the real estate property for |
| | a buyer |
| 1200 | Flow chart illustrates a method for providing the |
| | interactive virtual tour of the real estate property for |
| | a seller |
| 1300 | Screenshot showing an interactive virtual tour of a |
| | real estate property |
| 1302 | Call button |
| 1304 | Microphone |
| 1400 | Screenshot depicting various features of the real |
| | estate property while providing the interactive virtual |
| | tour of the real estate property |
| 1302 | Call button |
| 1304 | Microphone |
| 1500 | Screenshot depicting a feature associated with a |
| | kitchen while providing the interactive virtual tour of |
| | the real estate property |
| 1302 | Call button |
| 1304 | Microphone |
| 1600 | Screenshot depicting a feature associated with a |
| | dining hall and a decorative element while providing |
| | the interactive virtual tour of the real estate property |
| 1302 | Call button |
| 1304 | Microphone |

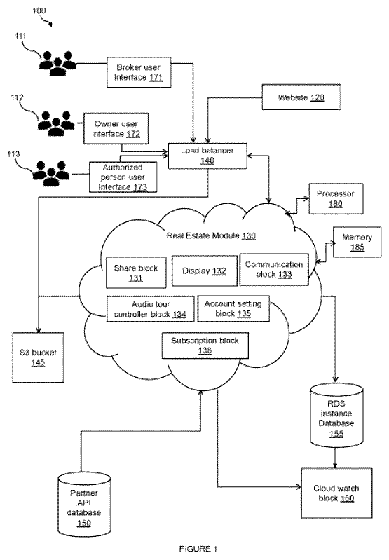

FIG. 1 illustrates a system 100 for providing the interactive virtual tour of the real estate property. The system 100 is, but not limited to, a cloud-based system. The system 100 may comprise subsystems, hardware, distributed computing, software, entity interfaces, and user interfaces which enable and deliver the services/functions of the present invention as described herein. The system 100 includes a website 120, a real estate module 130, a load balancer 140, an S3 bucket 145, a partner application programming interface (API) database 150, a Relational Database Service (RDS) instance database 155, a cloud watch block 160, a broker user interface 171, an owner user interface 172, an authorized person user interface 173, a processor 180 and a memory 185. Although, the real estate module 130 is shown in a cloud, but it is appreciated by those of skill in the art upon reading this application that the real estate module 130 may operate in cloud computing, a local server, a remote server, or on a user device, for example. Additionally, the local server may be selected to be (and includes within its meaning) an edge server, for example.

The real estate module 130 is accessed by one or more broker(s) (aka “agent, marketer or the like”) 111 through the broker user interface 171, one or more owner(s) 112 through the owner user interface 172, and one or more authorized person(s) 113 through the authorized person user interface 173 and one or more guest user(s) through the web site 120. The one or more broker(s) 111 through the broker user interface 171 and the one or more owner(s) 112 through the owner user interface 172 operate, upgrade, maintain and manage the real estate module 130. The at least one authorized person 113 through the authorized person user interface 173 and one or more guest user(s) through the website 120 interacts with the real estate module 130 to identify a suitable real estate property among the plurality of real estate properties.

The real estate module 130 itself is communicatively coupled to the user device (not shown). The user device can be a laptop, a notebook, a desktop computer, a vehicle to everything (V2X) device, a smartphone, a tablet, an internet of things (IoT) device, a television with communication facility, an immersive device, a virtual reality device, or any other computing device including similar hardened and field-specific devices, for example.

Further, the real estate module 130 acts as a core element of the system 100 and includes a share block 131, a display 132, a communication block 133, an audio tour controller block 134, an account setting block 135 and a subscription block 136. The display 132 can be, for example, but not limited to a light-emitting diode (LED) display, a Liquid Crystal Display (LCD) display, an edge display or the like.

The account setting block 135 allows for login or registration of the one or more broker(s) 111, the one or more owner(s) and a common user. The account setting block 135 saves a name of the user, a phone number of the user (e.g., one or more broker(s) 111, the one or more owner(s), common user or the like), an email ID of the user, a company name of the user or the like. The process of the login or the registration follows various existing techniques (e.g., one time password (OTP) based login/registration, facial recognition-based login/registration, fingerprint recognition-based login/registration or the like). Upon registering, the account setting block 135 authenticates the user. The process of the authentication follows various existing techniques (e.g., OTP based authentication, facial recognition-based authentication, fingerprint recognition-based authentication or the like). Upon the successful authentication, a homepage of the real estate module 130 is displayed on the display 132. If the authentication fails, then the account setting block 135 asks the user to reiterate the register/login process, whichever may deem fit.

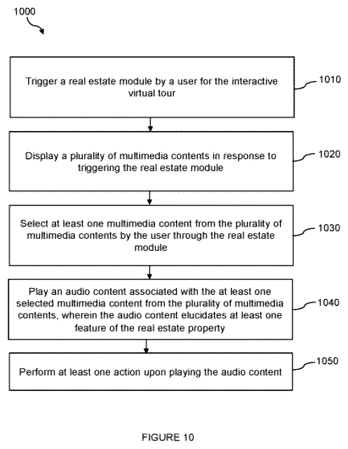

Upon the successful authentication, the audio tour controller block 134 triggers an application programming interface (API) for the audio tour. After triggering the API, the audio tour controller block 134 determines whether the API call is valid or not. In response to determining that the API call is valid, the audio tour controller block 134 triggers the real estate module 130. Whereas if the API call is not valid, the real estate module 130 is not triggered. Once triggered, the real estate module 130 displays a hosted audio tour output/server partner website output (explained below in FIG. 9) on the website 120. While displaying the hosted audio tour output/server partner website output, the audio tour controller block 134 fetches one or more photo(s) (i.e., multimedia content(s)) of the real estate property for the audio tour. The audio tour controller block 134 displays the one or more fetched photo(s) and allows the user to select the one or more fetched photo(s) (“at least one multimedia content”) to play and listen to the audio related to the real estate property. In an example, the authorized user 113 may provide a search query as “Show me real estates in Washington”. In response to the search query, the audio tour controller block 134 fetches the one or more real estates' photo(s) in Washington. The audio tour controller block 134 displays the one or more fetched real estates' photo(s). The user may select the photo from the one or more fetched photo(s) to listen to the audio. Accordingly, the audio tour controller block 134 playbacks the audio for the selected photo(s). The audio may elucidate one or more feature(s) of the real estate property. The one or more feature(s) can be selected from a list comprising, for example, but not limited to an address, a location, longitude, latitude, a specific information, a landmark, type, size, and cost associated with the real estate property.

Further, the audio tour controller block 134 performs one or more action(s) upon playing the audio (or audio content). The one or more action(s) can be, for example, but not limited to play back of the audio content, selection of at least one language from a plurality of languages (e.g., English language, German language, Arabic language, Chinese language, Hindi language or the like) to play the audio content, modification of an accent of the audio content, modification of a tone of the audio content, sharing of the audio content through the share block 131 (through e.g., Short Message Service (SMS), social media, chat or the like), and modification of an icon associated with the at least one selected multimedia content (e.g., image/photo, video or the like). For example, the user closes the icon associated with an image of the real estate property and the user expands the icon associated with the image of the real estate property.

Alternatively, upon the successful authentication, the audio tour controller block 134 displays the audio tour page/screen, the property card and an image and address on the property card on the display 132. The audio tour controller block 134 determines whether a click on the image is received from the user. If no click is determined or recognized, then the audio tour controller block 134 continues to display the property card to the user. If the click is determined or recognized, then the audio tour controller block 134 enables the user to click a lock icon on the property card and navigates to a subscriber model through the subscription block 136, where the subscription block 136 saves subscription details of the user. Also, the audio tour controller block 134 navigates to the audio tour screen and the image/photo gallery, on the display 132 respectively.

The audio tour controller block 134 allows the user to draft/create the property card and/or make changes to the published property card. During drafting/creation of the property card, the audio tour controller block 134 displays the image and the address of the real estate property. The audio tour controller block 134 allows the user to edit/modify the image and/or address on the display 132, where the user can further select preview showcase of the edited image and/or edited address. After the preview, the audio tour controller block 134 proceeds to publish the edited image and/or the edited address. The audio tour controller block 134 enables the user to confirm whether to publish the edited image and/or the edited address. Upon the confirmation to publish, the audio tour controller block 134 displays the image and the address, respectively.

In addition to creation/drafting of the property card, the audio tour controller block 134 allows the user to edit the published image and/or address on the display 132. Further, the audio tour controller block 134 provides an option to view showcase of the published edited image and/or edited address. After the showcase, the audio tour controller block 134 allows the user to share the edited image and/or the edited address through the share block 131.

The audio tour controller block 134 enables the user to record audio for a selected photo(s) of the real estate property. During the recording process, the user selects the photo gallery, where the audio tour controller block 134 displays a grid of photos associated with the real estate property. Although, the photo gallery is explained in view of the grid, however, the photo gallery is not restricted by any specific view. The user can select the photo from the photo gallery and record the audio with the selected photo. The user can then save the selected photo with the audio, where the audio tour controller block 134 indicates the audio associated with the saved photo.

While appending/adding the audio to the selected photo, the audio tour controller block 134 navigates the selected photo to a recording studio panel. The audio tour controller block 134 displays and indicates the recorded audio with the selected photo using an indicia, for example, a play button, a pause button, a stop button, a length of the audio, the timeline of the audio, re-record audio information option and delete audio information option.

In addition to the above information, the real estate module 130 obtains a first input associated with the real estate property from a first user (e.g., buyer) to identify (or to shortlist) the real estate property from the plurality of real estate properties. In other words, the real estate module 130 receives the first input from the first user, which includes the preferences, the historical transaction data, and the market trends. This input helps the system 100 to identify the real estate property from a range of available properties. By analyzing the user's preferences, past transaction history, and current market trends, the real estate module 130 is able to recommend properties that align with the buyer's needs and investment goals, streamlining the property selection process.

The real estate module 130 further uses the data-driven model to identify and display the most suitable real estate property from the available selection based on the first input. This approach leverages the input data to narrow down the options and present the properties that best align with the buyer's needs and market conditions, providing a personalized and efficient property search experience.

The real estate module 130 obtains a second input associated with the real estate property from the first user to fine-tune listing of the real estate property obtained after the first input. In other words, the real estate module 130 receives the second input from the first user to further refine the listing of real estate properties initially generated from the first input. This second input includes specific property preferences, budget constraints, and location criteria. By incorporating these additional factors, the real estate module 130 fine-tunes the property recommendations to better match the buyer's requirements, ensuring a more tailored and relevant selection of available properties.

The real estate module 130 further utilizes the data-driven model to recommend and predict the most suitable real estate property from the available options based on the second input. The real estate module 130 analyzes the input data to generate a personalized list of properties that best align with the user's specific needs, ensuring that the recommendations are both relevant and within the buyer's budget and preferred location.

The real estate module 130 receives a third input to select the real estate property obtained after the second input. In other words, the real estate module 130 receives the third input from the user to finalize the selection of the real estate property based on the refined list generated after the second input. This third input helps narrow down the options further, allowing the user to choose the property that best meets their needs, preferences, and criteria.

The first user selects the real estate property from the plurality of real estate properties. Upon selection, the real estate module 130 activates a conversation mode to enable the audio mode to explain the feature of the selected real estate property from the plurality of real estate properties. In other words, the real estate module 130 facilitates the first user the selection of a real estate property from a range of available options. Once the user identifies and selects their preferred property, the system 100 triggers a conversation mode, transitioning to audio mode to provide an engaging, detailed explanation of the features of the selected property. In this mode, the real estate module 130 highlights key aspects such as the layout, design, amenities, and unique characteristics of the property. For example, the audio might describe the spacious living areas, modern kitchen, luxury finishes, and any distinctive features such as a private backyard or energy-efficient appliances. The system 100 may also include contextual information like the neighborhood or nearby amenities, ensuring the user gains a comprehensive understanding of the property, all through an interactive, hands-free audio experience. This detailed explanation is tailored to enhance the user's decision-making process, making the property selection more informed and personalized.

The real estate module 130 may receive a query from the first user about the selected real estate property from the plurality of real estate properties. The query can be, for example, but not limited to a text query, an audio query and a gesture query. Based on the query, the real estate module 130 provides a response about the selected real estate property to the first user. The response elucidates a feature of the real estate property. The response is an audio response. The response describes the address, the location, the longitude, the latitude, the specific information, the landmark, the type, the size, and the cost associated with the selected real estate property.

As mentioned above, once the query is received, the system 100 processes it and provides a detailed audio response that addresses the user's inquiry. For instance, if the user asks about the property's location or size, the response will describe the property's address, including the specific location, longitude, latitude, and nearby landmarks. It will also provide detailed information about the property, such as its type (e.g., single-family home, apartment), its size (e.g., square footage or number of bedrooms), and the cost associated with purchasing or renting the property. The audio response is designed to be comprehensive and clear, helping the user make an informed decision about the selected property.

The real estate module 130 also analyzes the market trend, the historical listing, and the property feature associated with the real estate property from the plurality of real estate properties, over a period of time (for example one year), to determine the valuation and marketing strategy for the real estate property.

By evaluating data such as property pricing trends, past sale listings, and changes in demand for similar properties, the real estate module 130 determines the optimal valuation for the selected real estate property. Additionally, the real estate module 130 assesses key features of the property, including location, size, condition, and amenities, to craft a tailored marketing strategy. This strategy may include targeted advertising, pricing recommendations, and promotional tactics designed to maximize interest and attract potential buyers or renters. The system's analysis ensures that the property's market positioning is competitive and aligned with current market conditions, helping sellers or agents to achieve the best possible outcome.

The real estate module 130 estimates the market value for the real estate property by analyzing each comparable real estate property from the plurality of real estate properties, location-specific data, and property characteristics associated with the real estate property. In other words, the real estate module 130 estimates the market value for the selected real estate property by conducting a thorough analysis of several key factors. First, it examines comparable real estate properties (comps) from the available listings, taking into account similar properties in the same or nearby locations that have recently been sold or are currently listed. The system 100 also incorporates location-specific data, such as neighborhood trends, proximity to key amenities, and overall demand in the area, to provide a more accurate assessment. In addition, the real estate module 130 evaluates the unique characteristics of the selected property, including its size, condition, age, features (such as number of bedrooms or a pool), and any upgrades or unique amenities. By synthesizing all these factors, the system 100 provides the estimated market value for the property, helping potential buyers and sellers make informed decisions based on current market conditions and comparable properties.

The real estate module 130 also obtains publicly available data including an image, a video, a map, a blueprint, historical pricing trends, population density, crime rate, square footage, unique home feature, demographic details and property characteristics (e.g., square footage, unique features, tax appraisals). In other words, the real estate module 130 gathers the wide range of publicly available data to provide a comprehensive analysis and listing of a real estate property. This includes visual and informational resources such as images, videos, and maps of the property and its surrounding area, offering users a clear view of both the exterior and interior of the home. The system 100 also obtains blueprints or floor plans, providing insights into the property's layout and design. The historical pricing data is collected to show trends in the property's market value over time, helping users understand its appreciation or depreciation. In addition, the real estate module 130 gathers demographic information, such as population density in the area, crime rates, and other factors that may influence the desirability of the location. Property-specific details, like square footage, unique home features (e.g., a home theater, smart home capabilities, or eco-friendly features), and the latest tax appraisal values, are also included in the data. By integrating all these diverse data points, the real estate module 130 delivers a detailed and well-rounded overview of the property, assisting users in making informed decisions based on a variety of important factors.

The real estate module 130 generates the detailed property listing for the real estate property based on the valuation and marketing strategy, the estimated market value and the publicly available data. In other words, the real estate module 130 generates a detailed property listing for a selected real estate property by synthesizing a variety of key factors. First, the system 100 incorporates the valuation and marketing strategy, which includes insights drawn from market trends, historical data, and property features to determine an optimal pricing and promotional approach. The estimated market value of the property, calculated through an analysis of comparable properties, location data, and property-specific attributes, is also included to provide an accurate reflection of its current worth. This detailed listing, as mentioned above, not only showcases the property's features and competitive market value but also highlights its advantages and potential, effectively attracting potential buyers or renters by offering a clear, data-driven overview.

The real estate module 130 obtains the first input associated with the real estate property from the second user (e.g., seller) to display the real estate property from the plurality of real estate properties. In other words, the real estate module 130 receives the first input from the second user (e.g., seller) to display the real estate property from the selection of available properties. This input includes several critical factors such as the seller's listing preferences, which may specify details like the desired property features to highlight, the type of potential buyers they wish to target, or any special requirements for showcasing the property. Additionally, the input includes the seller's desired price range, helping to set the property's listing price within a competitive and realistic range based on current market conditions. The marketing goal is also provided, which may encompass objectives such as maximizing visibility, targeting specific demographics, or focusing on a quick sale. By incorporating this information, the real estate module 130 tailors the property display to align with the seller's specific preferences and goals, ensuring the property is presented in the best possible way to attract the right buyers and meet the seller's expectations.

Once the real estate property has been listed by the second user, the real estate module 130 receives the second input from the first user (e.g., buyer) to select the real estate property from the plurality of real estate properties. Based on this input, the real estate module 130 filters through the plurality of real estate properties, narrowing down the options to those that best match the buyer's preferences as mentioned above. The system 100 may also factor in additional considerations such as proximity to schools, transportation, or other personal requirements provided by the buyer. By analyzing these preferences, the real estate module 130 allows the buyer to focus on the most relevant properties, streamlining the property selection process and enhancing the overall experience.

Based on the second input, the real estate module 130 activates the conversation mode, transitioning to audio mode to provide an interactive explanation of the selected real estate property. As the user navigates through the property details, the real estate module 130 listens to queries from the user, which could pertain to specific aspects of the property, such as its layout, features, or amenities. For example, if the user asks about the size of the kitchen or the age of the roof, the system 100 processes the query and responds with detailed, contextually relevant information. The audio response elucidates key features of the property, such as the number of rooms, square footage, type of flooring, unique home features (like a fireplace or smart home systems), and any recent renovations. It may also include additional information such as the property's location, neighborhood amenities, or pricing. This interactive, audio-driven response allows the user to gain a deeper understanding of the property in a personalized, hands-free manner, enhancing their decision-making process.

The real estate module 130 schedules the virtual tour for the selected real estate property, offering a fully immersive 3D interactive experience. Upon receiving the request, the real estate module 130 customizes the tour to be delivered in the preferred language of either the first user (e.g., buyer) or the second user (e.g., seller) based on natural language processing (NLP), ensuring that the information is easily understood. The 3D interactive tour allows users to navigate through the property at their own pace, exploring rooms, viewing detailed floor plans, and experiencing features like the kitchen, living spaces, and outdoor areas from various angles. The real estate module 130 provides contextual details as the user interacts with the tour, offering audio or text descriptions of each room's features, dimensions, and key highlights. The virtual tour is designed to replicate the feeling of walking through the property in person, enabling the user to visualize the space and make informed decisions. By offering this personalized and accessible experience, the real estate module 130 ensures that users can thoroughly explore the property from anywhere, in their preferred language, at a time that suits them.

The real estate module 130 facilitates selection of the relevant multimedia content from the plurality of multimedia contents associated with the selected real estate property, chosen by the first user. This multimedia content can include images, videos, and audio files that highlight different aspects of the property. Once the multimedia content is selected, the system 100 plays the associated audio content, which may provide a detailed description of the property's features, such as room dimensions, amenities, and unique characteristics. Upon playing the audio content, the system 100 offers several interactive actions to enhance the user experience. These actions can include adjusting the language in which the audio content is played, allowing the users to select their preferred language from a variety of options. Additionally, the real estate module 130 allows the user to modify the accent or tone of the audio content for a more personalized listening experience. The users can also share the audio content with others or adjust the icon associated with the multimedia content to better suit their preferences or the platform's interface. These features ensure a dynamic and customizable interaction with the multimedia content, offering a flexible, user-friendly way to explore the real estate property in detail.

The real estate module 130 generates and recommends a tailored offer for the selected real estate property from the available listings based on various factors, including the user's preferences, market data, and property characteristics. The system 100 analyzes details such as the property's valuation, location, features, and historical pricing trends, as well as the buyer's budget and specific requirements. It then creates an offer that is both competitive and aligned with the buyer's needs, potentially factoring in variables such as negotiation flexibility, possible incentives (e.g., closing cost assistance), or specific terms related to the purchase. Once the offer is generated, the real estate module 130 recommends it to the buyer or the seller, presenting a clear breakdown of the offer's terms, including the proposed price, payment structure, and any additional conditions or incentives. The recommendation is designed to assist the buyer in making an informed decision by offering a well-structured proposal that balances the buyer's expectations with the current market environment. Additionally, the system 100 may suggest adjustments or improvements to the offer based on real-time market trends, ensuring that the buyer remains competitive in the property search process.

The real estate module 130 may receive a counter-offer for the selected real estate property, typically in response to an initial offer made by the seller or the buyer. The real estate module 130 analyzes the counter-offer, taking into account factors such as the revised price, terms, conditions, and any other changes presented by the seller. Using this information, the system 100 generates two potential options for the buyer: a pre-final offer and a final offer.

The pre-final offer is designed to act as a negotiation tool, presenting terms that are slightly adjusted from the buyer's original offer, potentially offering a middle ground between the buyer's initial proposal and the seller's counter-offer or vice-versa. The final offer, on the other hand, is a more definitive proposal that is carefully crafted based on market trends, comparable property prices, and the buyer's budget and preferences. It represents the buyer's most competitive terms and aims to close the deal with the best possible outcome.

In short, the system 100 recommends both the pre-final and final offers to the buyer, providing a comprehensive breakdown of each option. This includes factors such as the price adjustments, any concessions or incentives offered, and an explanation of how each offer aligns with market conditions and the buyer's negotiation strategy. The module's suggestions are aimed at helping the buyer make an informed decision, enhancing the chances of successfully negotiating and finalizing the transaction for the selected property.

The real estate module 130 determines that at least two real estate properties from the plurality of real estate properties are selected by the first user. The real estate module 130 tracks and visualizes the at least two real estate properties from the plurality of real estate properties selected by the first user. The real estate module 130 compares and recommends the feature of the at least two real estate properties on the virtual offer grid interface. In other words, the real estate module 130 also determines if the first user has selected at least two real estate properties from the available listings. Once these properties are selected, the real estate module 130 tracks and visualizes them on an intuitive interface, providing the user with a clear side-by-side view of each property. This visualization allows the user to easily compare key features such as property size, number of bedrooms, location, price, and unique amenities (e.g., pools, home offices, or smart home technology).

The real estate module 130 then utilizes this data to generate a comparison on a virtual offer grid interface, which presents the properties in a user-friendly format. On the grid, the real estate module 130 highlights both the similarities and differences between the properties, such as design elements, square footage, or proximity to local amenities like schools, parks, or transportation hubs, for example. The real estate module 130 may also recommend specific features to focus on based on the user's preferences and the current market trends, helping the buyer make a more informed decision. This comparison tool empowers the first user to weigh their options effectively, providing a visual and data-driven approach in selecting the ideal property.

The real estate module 130 evaluates and provides a score for the at least two real estate properties selected by the user on the virtual offer grid interface. The scoring system is based on a comprehensive analysis of various factors, such as property features (e.g., square footage, number of bedrooms, condition, and amenities, for example), location (proximity to schools, work, or public transportation, for example), market trends, and the property's estimated market value, for example. The real estate module 130 assigns the score to each property to help the user quickly assess which option(s) aligns best with their preferences and needs.

The scores are displayed clearly on the virtual offer grid interface, allowing the user to compare properties side by side. For example, one property may receive a higher score for its larger size or better location, while another may score higher due to its more modern features or lower price point. These scores are accompanied by detailed breakdowns, providing insights into how each factor contributes to the overall rating. The scoring system not only highlights the relative advantages and disadvantages of each property but also serves as a decision-making tool, enabling the user to make an informed and confident choice when selecting the ideal real estate property.

The virtual offer grid interface serves as a comprehensive, AI-powered tool that assists sellers by tracking all received offers and presenting a visual summary of each offer's essential terms. When offers are submitted, the module organizes them within the virtual offer grid interface, displaying key components such as offer price, financing type, contingencies, proposed closing timelines, and any additional terms specific to each offer.

The virtual offer grid interface enables the sellers and the buyers to easily compare multiple offers in a side-by-side format, allowing them to quickly assess the strengths and weaknesses of each option. For instance, the AI model may highlight offers with favorable financing (such as cash offers) or minimal contingencies, making them more appealing for a quick close. Additionally, the module 130 can rank offers based on alignment with the seller's (or buyer's) priorities, such as maximizing price or reducing time on the market.

As offers evolve or new bids are received, the virtual offer grid interface updates in real time, ensuring that sellers and buyers have an up-to-date view of all active offers. This interactive, visual summary provides sellers and buyers with a clear, data-driven basis for evaluating competing offers and facilitates strategic decision-making, ultimately helping them to select the most advantageous offer with confidence.

The AI model enhances the offer grid interface by analyzing each offer's potential value and interest level. For the buyers, the AI model evaluates how well each property aligns with their preferences and budget, while for sellers, it assesses how each offer meets their goals, such as maximizing price or ensuring a quick sale. The AI model assigns priority levels to each option and suggests actions based on its analysis, like moving forward with a high-priority offer or adjusting terms on a lower-ranked one to make it more competitive.

Furthermore, the AI model continuously updates the offer grid interface as new offers or properties are added, or as existing ones change, providing users with real-time insights. This interactive functionality empowers users to make informed, data-driven decisions by highlighting the most promising opportunities and guiding their next steps, ultimately enhancing the efficiency and clarity of the property or offer evaluation process.

The offer grid interface leverages predictive analytics to provide users with a forecasted view of each offer's likelihood of success, enhancing their ability to make strategic decisions. By analyzing historical closing data from similar transactions, the AI behind the offer grid interface identifies patterns and outcomes that typically lead to successful closings. For example, it assesses variables like offer price, financing method, contingencies, and response time, comparing them to past data to estimate each offer's chances of acceptance or favorable negotiation.

With this predictive insight, the offer grid interface can assign a “success probability” to each offer, displaying these probabilities alongside the offer details. The users can quickly see which offers are most likely to proceed to closing based on comparable cases, allowing them to prioritize offers with higher probabilities of success. For instance, the AI might flag a cash offer with no contingencies as having a high likelihood of closing, while offers with financing contingencies or longer closing timelines may receive lower success ratings.

This forecasted view helps both buyers and sellers set realistic expectations and make more informed choices about pursuing, countering, or improving specific offers. By visualizing potential outcomes, the offer grid interface empowers users to approach the negotiation and decision-making process with confidence, backed by data-driven insights into each offer's projected viability.

The real estate module 130 provides negotiation assistance by analyzing each offer in relation to historical transaction data and suggesting optimized counter-offer terms. When the offer is received, the AI model evaluates its components—such as price, contingencies, and financing type—against a database of similar past transactions to determine its competitiveness and potential for acceptance.

The real estate module 130 collects and analyzes a variety of data over a period of time to better understand the preferences and behaviors of the first user (e.g., buyer) or the second user (e.g., seller). This includes gathering user preferences, such as desired property features, budget, location, and style, as well as interaction data, such as how the user interacts with different property listings, which properties they spend the most time viewing, and which ones they inquire about. Additionally, the system 100 captures the feedback from the user, such as ratings, comments, or specific queries related to properties they have expressed interest in.

By processing this accumulated data, the real estate module 130 tailors its recommendations to the user's specific needs and desires. For example, if the user frequently engages with properties that are within a certain price range or have particular amenities, the system 100 takes these preferences into account to suggest similar properties. The real estate module 130 may also adjust its recommendations based on feedback provided by the user, ensuring that the properties suggested align with their evolving tastes or requirements. These personalized property recommendations are designed to make the search process more efficient and targeted, improving the overall user experience and increasing the likelihood of finding the perfect property.

The real estate module 130 displays the estimated real estate property cost, contingency associated with the real estate property, and relative competitiveness of each property. The real estate module 130 verifies the completeness and accuracy of a document (including coordination of the signatures) associated with the real estate property by cross-referencing it with both local regulation requirements and transaction requirements. For example, if the document is a property deed, purchase agreement, or disclosure form, the system 100 first checks if it complies with local zoning laws, building codes, and other regional regulations that govern property transactions. It ensures that all necessary signatures, legal descriptions, and disclosures are included and meet the standards set by local authorities.

Additionally, the real estate module 130 cross-references the document with transaction-specific requirements, such as terms outlined in the buyer's offer or the seller's listing, financing conditions, and any contingencies related to inspections or appraisals. By comparing the document against these requirements, the system 100 verifies that all critical elements are present and accurate, helping to avoid potential legal or transactional issues. The real estate module 130 alerts the user (e.g., buyer, seller, or agent) if any discrepancies or missing information are found, ensuring that the document is fully compliant and ready for processing, which streamlines the transaction and minimizes the risk of delays. Throughout this process, all documents are securely stored and managed within a centralized digital system, allowing clients to access their paperwork and track transaction progress. This streamlined approach not only reduces manual intervention but also enhances security, organization, and accessibility of transaction documents, providing the clients with a seamless and efficient experience in offer submission and management. This feature provides transparency and ensures that the buyer is informed about potential inspection-related concerns.

The real estate module 130 indicates a mortgage option and interest rate for the selected real estate property by analyzing a variety of factors, including the property's value, the buyer's financial profile, and current market conditions. Based on these inputs, the system 100 suggests appropriate mortgage options, such as fixed-rate mortgages, adjustable-rate mortgages (ARMs), or government-backed loans (e.g., FHA, VA loans), which are tailored to the buyer's preferences and eligibility. Additionally, the real estate module 130 provides the corresponding interest rate for each mortgage option, which is determined by factors like the buyer's credit score, down payment amount, and loan term (e.g., 15 or 30 years). The system 100 may also factor in market trends and current interest rates to provide the most competitive rates available. Along with the interest rate, the real estate module 130 includes an estimated monthly payment calculation, factoring in the loan amount, term length, and interest rate, to help the buyer assess affordability and make an informed decision about which mortgage option is best suited for their financial situation. The real estate module 130 ensures that the buyer has a comprehensive understanding of the available mortgage options and associated costs, simplifying the decision-making process for property financing.

The real estate module 130 identifies common inspection issues for the selected real estate property by analyzing its type (e.g., single-family home, apartment, condo) and location (e.g., urban area, suburban neighborhood). The system cross-references property type and location with a database of typical inspection concerns, such as roofing issues, foundation cracks, plumbing problems, or electrical system faults, which are common for properties in that particular area or of that particular type. For example, the real estate module 130 may identify that older homes in a specific neighborhood often have issues with outdated electrical wiring or that properties in flood-prone areas may require additional attention to drainage systems or waterproofing. Also, an AI-driven inspection and tracking process provides the users with a clear, organized view of inspection outcomes and follow-up actions, minimizing the risk of overlooked issues and ensuring a thorough, efficient due diligence process.

Once a potential inspection issue is identified, the system 100 coordinates a follow-up action, which could include scheduling a professional inspector to assess the property, providing the user with a list of certified inspectors in the area, or offering recommendations for necessary repairs or upgrades. The real estate module 130 may also notify the user (buyer or seller) of any issues that could affect the property's value or insurance costs, ensuring that the user is well-informed and can take proactive steps to address the problem before moving forward with the transaction. By identifying and addressing common inspection issues early, the real estate module 130 helps streamline the buying or selling process, preventing surprises and ensuring a smoother transaction.

The real estate module 130 performs predictive analytics to suggest areas with growth potential by analyzing a combination of demographic data, economic data, and property value trends. The system 100 first examines demographic data, including population growth, age distribution, income levels, and migration patterns, to identify regions experiencing an influx of residents or shifts in the socioeconomic landscape. It then incorporates economic data, such as employment rates, income growth, infrastructure development, and local business activity, to gauge the economic health and future growth prospects of different areas.

Additionally, the real estate module 130 analyzes property value trends, looking at historical pricing data, price appreciation rates, and sales volumes across various neighborhoods. By synthesizing these factors, the system 100 identifies areas where property values are likely to increase in the future due to strong demand, improved economic conditions, or ongoing development projects such as new schools, transportation links, or commercial centers.

Based on this analysis, the real estate module 130 recommends specific areas with high growth potential, helping users—whether they are buyers, investors, or real estate professionals—make informed decisions about where to focus their efforts. The recommendation could include a detailed breakdown of why the area is expected to experience growth, including insights into local market conditions and future opportunities, ensuring the user is positioned to make a wise, data-driven investment.

The real estate module 130 displays and ranks the received offers for a selected real estate property based on a set of predefined parameters, including the offer amount, contingencies, and financing options. When an offer is received, the system 100 first evaluates the offer amount, considering how it compares to the asking price and other competing offers. A higher offer amount may be ranked more favorably, but the system 100 also considers other factors that could influence the overall quality of the offer.

Next, the real estate module 130 examines any contingencies included in the offer, such as contingencies for financing, inspections, or the sale of another property. Offers with fewer or more favorable contingencies (e.g., a clean offer without a financing contingency or a short inspection period) are ranked higher, as they represent less risk for the seller and are more likely to close quickly.

The system 100 also reviews the financing terms outlined in the offer, including the buyer's ability to secure a mortgage, the type of financing (e.g., conventional loan, FHA loan, cash offer), and the proposed down payment. Offers with stronger financing, such as a larger down payment or a pre-approved loan, may be ranked more favorably, as they reduce the likelihood of issues during the transaction process.

Once all these parameters are evaluated, the real estate module 130 displays a ranked list of offers, giving the seller a clear view of each offer's strengths and weaknesses. This ranking helps the seller make an informed decision, taking into account not just the offer amount, but also the reliability and likelihood of a successful transaction based on contingencies and financing.

The real estate module 130 performs a targeted online marketing plan for a selected real estate property by analyzing the demographics and activity patterns of the first user (e.g., buyer). The system 100 gathers data on the user's preferences, behavior, and interactions with various properties, including the types of properties they have shown interest in, their browsing history, and specific features they value (e.g., location, price range, number of bedrooms). Additionally, the real estate module 130 examines demographic data such as the user's age, income level, family size, and geographic location to build a more complete profile of their potential needs and preferences.

Based on this data, the real estate module 130 creates a tailored marketing plan that targets the user with personalized property recommendations and advertisements. This may include displaying properties that match the user's criteria across various online platforms, such as real estate websites, social media, or email campaigns. The marketing plan also optimizes the timing and content of the messages, ensuring they align with the user's activity patterns—such as sending alerts for newly listed properties when the user typically browses or providing reminders about properties they've previously viewed.

The real estate module 130 can further refine the marketing plan by segmenting the audience into specific groups based on similar demographics and behaviors, ensuring that marketing efforts are directed towards those most likely to be interested in the property. This targeted approach increases the likelihood of engaging the first user with relevant, compelling listings, thereby improving the efficiency of the marketing campaign and enhancing the user's experience in finding the right property. Also, the real estate module 130 autonomously posts a listing across selected platforms, such as major real estate websites, social media channels, and regional MLS databases. To maintain listing accuracy and maximize market presence, the real estate module 130 synchronizes all platforms, ensuring that any updates to property details, such as price adjustments or new photos, are reflected universally and in real time.

The real estate module 130 updates a property pricing recommendation by analyzing and incorporating real-time data, including the current market value, seasonal trends, and buyer interest levels. The system 100 first evaluates the market value of the property, using up-to-date data on comparable property sales in the same area, historical price trends, and the condition of the property. This helps to determine whether the property is priced competitively based on recent market activity.

In addition to market value, the real estate module 130 also considers seasonal trends, recognizing that property values can fluctuate depending on the time of year. For example, the real estate module 130 might factor in the typical increase in home prices during the spring and summer months when the market is more active or adjust pricing based on slower sales cycles in the winter. By taking these seasonal trends into account, the real estate module 130 helps ensure that the price recommendation is aligned with broader market conditions.

The real estate module 130 also assesses buyer interest levels, which are tracked through real-time engagement data such as property views, inquiries, and offers on similar listings. If the system 100 detects a high level of buyer interest in a particular neighborhood or property type, it may recommend adjusting the price to take advantage of increased demand. Conversely, if buyer interest is lower than expected, the real estate module 130 might suggest a price reduction to attract more potential buyers. By combining these real-time data points-market value, seasonal trends, and buyer interest levels—the real estate module 130 continuously updates its property pricing recommendation to reflect the most accurate and current information. This dynamic pricing approach ensures that the property remains competitive in the market, maximizing the seller's chances of a successful transaction.

The real estate module 130 evaluates the financial qualification and likelihood of successful transaction completion for a potential first user (e.g., a buyer) by analyzing key financial data and transaction history. First, the system 100 assesses the user's financial qualification by reviewing factors such as credit score, income level, debt-to-income ratio, employment history, and available down payment. This analysis helps the real estate module 130 determine the user's ability to secure financing for a real estate purchase, such as through a mortgage loan, and to ensure they meet the necessary financial criteria for a specific property. The real estate module 130 also provides a real-time, AI-driven financing guidance that helps the clients navigate loan options with confidence, understand cost implications, and make informed financial decisions in preparation for closing.

Next, the real estate module 130 evaluates the user's history of successful transactions, including past property purchases or sales, if applicable, to assess their reliability and ability to complete a transaction smoothly. This may include examining the user's history of making timely payments, fulfilling contract terms, and closing deals on previous transactions. The real estate module 130 may also consider external factors such as any prior instances of default, foreclosure, or failed transactions to gauge the user's risk profile.

By combining both the financial qualification and transaction history, the real estate module 130 provides a comprehensive assessment of the first user's likelihood to successfully complete a property transaction. Based on this evaluation, the system 100 may recommend suitable properties within the user's financial reach, suggest appropriate mortgage options, or notify the user of any financial adjustments needed to improve their qualification for a successful purchase. This process helps ensure that the user is both financially capable and well-positioned to move forward with a property transaction.

The real estate module 130 facilitates the scheduling and management of open house events, ensuring a seamless experience for both sellers and prospective buyers. When the seller decides to hold an open house, the module 130 selects optimal dates and times based on local buyer activity patterns, maximizing attendance by aligning the event with peak viewing times.

The real estate module 130 integrates with online scheduling tools, allowing prospective buyers to RSVP in advance, which aids in managing visitor flow and avoiding overcrowding during the open house. On the day of the event, the AI model tracks attendance, provides visitor check-in capabilities, and monitors engagement levels, ensuring the open house is well-organized and accommodating.

After the open house, the real estate module 130 automates follow-up communication with attendees, sending personalized messages to thank them for visiting and offering additional information on the property or options to schedule private tours. For high-interest attendees, the AI model may also provide timely updates or reminders about the property. This end-to-end coordination of open house events improves visitor experience, increases engagement, and enhances the likelihood of generating qualified leads for the seller.

In an embodiment of the present invention, the system 100 comes with the capabilities of the data driven model (e.g., AI (Artificial Intelligence) model or a machine learning (ML) model) that implements a machine learning method called deep learning. The machine learning method enables the system 100 to automatically learn and improve from experience, over a period of time, without being explicitly programmed. The deep learning method uses a neural network capable of learning in an unsupervised manner from data that is unstructured or unlabeled. Deep learning is a method of machine learning that employs multiple layers of neural networks that enable the platform of the present invention to teach itself through inference and pattern recognition, rather than development of procedural code or explicitly coded software algorithms (however, machine learning is augmented and enhanced with software algorithms). The neural networks are modeled according to the neuronal structure of a mammal's cerebral cortex, where neurons are represented as nodes and synapses are represented as uniquely weighted paths or “tolled roads” between the nodes. The nodes are then organized into layers to comprise a network. Additionally, the neural networks are organized in a layered fashion that includes an input layer, intermediate or hidden layers, and an output layer.

The neural networks enhance their learning capability by varying the uniquely weighted paths based on received input. The successive layers within the neural network incorporate the learning capability by modifying their weighted coefficients based on their received input patterns. From this foundation, one can see that the training of the neural networks is very similar to how we teach children to recognize an object. The neural network is repetitively trained from a base data set, where results from the output layer (or, simply “output”) are successively compared to the correct classification.

Alternatively, any machine learning paradigm instead of neural networks can be used in the training and learning process. The AI unit supports several different algorithms oriented towards the real estate service.

The communication block 133 enables and simplifies communication between all of participants/users of the system 100 by bringing an instant messaging layer as a central mode of communication among each other. Further, the communication block 133 enables communication among all the components of the system 100.

The processor 180 comprises one or more processing units, which may be configured to perform all the processing functionalities of the present invention. The one or more processing units may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU), for example. Further, functions associated with the real estate module 130 may be performed by utilizing the information stored in the memory 185 like a non-volatile memory, volatile memory, for example and by utilizing the processor 180. The memory 185 stores the information/data relevant to fulfil the methods described herein.

The load balancer 140 manages the load/traffic on the real estate module 130 and the S3 bucket 145 when the one or more broker(s) 111, the one or more owner(s) 112, the at least one authorized person 113, and the one or more guest user(s) access the real estate module 130 at a time. The S3 bucket 145 is a public cloud storage resource database for storing information corresponding to the real estate properties and the one or more broker(s) 111, the one or more owner(s) 112, the at least one authorized person 113, and the one or more guest user(s). The S3 bucket 145 also stores one or more audio files associated with the audio content and system logs.

The partner API database 150 is a source for listing data from the one or more owner(s) 112. The RDS instance database 155 is a collection of managed services that makes it simple to set up, operate, and scale databases in the cloud. The RDS instance database 155 is coupled with the cloud watch block 160 and the real estate module 130. The partner API database 150 and the RDS instance database 155, generally, may be realized through various technologies such as, but not limited to, Microsoft® SQL, Access®, Azure®, Oracle IBM DB2®, PostgreSQL®, MySQL® and SQLite®, and the like. The cloud watch block 160 stores various logs of the real estate properties and the one or more broker(s) 111, the one or more owner(s) 112, the at least one authorized person(s) 113, and the guest users. Also, the cloud watch block 160 monitors resource of the real estate property, a service condition of the real estate property and status of the real estate property.

Although FIG. 1 shows various components of the system 100 but it is to be understood that other embodiments are not limited thereon. The system 100 may include less or more number of components. Further, the labels or names of the components are used only for illustrative purpose and do not limit the scope of the present invention. One or more components can be combined together to perform same or substantially similar function in the system 100.

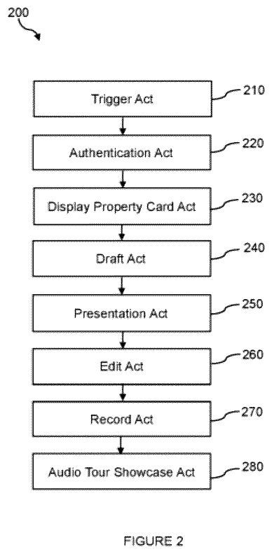

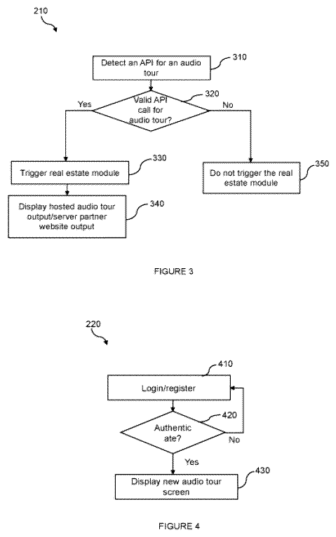

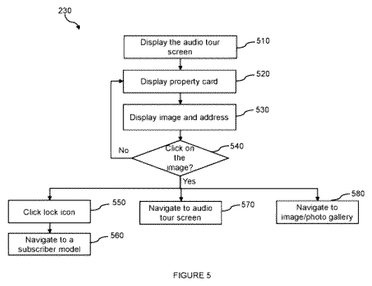

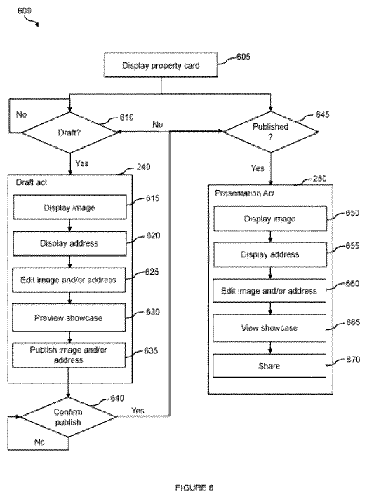

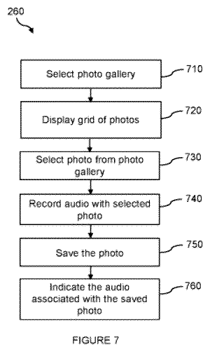

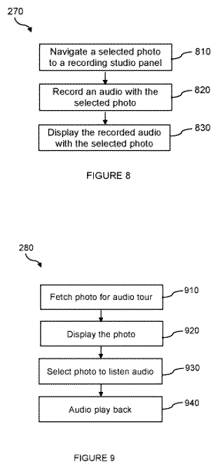

Now simultaneous reference is made to FIG. 2 through FIG. 9, in which FIG. 2 is a flow chart illustrating various acts (aka “interactive virtual tour algorithm”) 200 to provide the interactive virtual tour of the real estate property; FIG. 3 is a flow chart illustrating a trigger act 210 in conjunction with FIG. 2; FIG. 4 is a flow chart illustrating an authentication act 220 in conjunction with FIG. 2; FIG. 5 is a flow chart illustrating a display property card act 230 in conjunction with FIG. 2; FIG. 6 is a flow chart illustrating a virtual tour creation algorithm 600 using a draft act 240 and a presentation act 250 in conjunction with FIG. 2; FIG. 7 is a flow chart illustrating an edit act 260 in conjunction with FIG. 2; FIG. 8 is a flow chart illustrating a record act 270 in conjunction with FIG. 2; and FIG. 9 is a flow chart illustrating an audio tour showcase act 280 in conjunction with FIG. 2.

The operations begin at the trigger act 210. The trigger act 210 is explained in detail in FIG. 3. In the trigger act 210, at step 310, the audio tour controller block 134 detects the API for the audio tour. After detecting the API, at step 320, the audio tour controller block 134 determines whether the API call is valid or not. At step 330, in response to determining that the API call is valid, then the audio tour controller block 134 triggers the real estate module 130. At step 340, upon triggering the real estate module 130, the real estate module 130 displays the hosted audio tour output/server partner website output (explained below in FIG. 9). At step 350, in response to determining that the API call is not valid, the real estate module 130 does not get triggered.

Following the trigger act 210, the authentication act 220 begins, which is explained in conjunction with FIG. 4. Referring to FIG. 4, in the authentication act 220, at step 410, the account setting block 135 allows the user to login or register himself/herself. The process of the login or the registration follows various existing techniques. At step 420, upon registering, the account setting block 135 authenticates the user using at least one of a various existing technique. Upon the successful authentication, at step 430, the account setting block 135 displays the audio tour screen on the display 132. If the authentication fails, then the account setting block 135 iterates the process of registration.

In an embodiment, the trigger act 210 is performed first and then authentication act 220 is performed. In another embodiment, the authentication act 220 is performed first and then the trigger act 210 is performed.

Following the authentication act 220, the display property card act 230 begins which is explained in conjunction with FIG. 5. At step 510, step 520, and step 530, the audio tour controller block 134 displays the audio tour screen, the property card and the image and address on the property card, respectively, through the display 132. At step 540, the audio tour controller block 134 determines the click (or any sensory input) received from the user on the image. If no click is determined or recognized, then the operation moves back to step 520 to display the property card. If the click is determined or recognized, then at step 550 and step 560, the audio tour controller block 134 enables the user to click the lock icon on the property card and navigates to a subscriber model through the subscription block 136, respectively. At step 570 and step 580, the audio tour controller block 134 navigates to the audio tour screen and the image/photo gallery, respectively.

Following the display property card act 230, the virtual tour creation algorithm 600 incorporating the draft act 240 and the presentation act 250 begins as shown in FIG. 6. In an embodiment, at step 605, the audio tour controller block 134 displays the property card. The audio tour controller block 134 determines, at steps 610 and 645, whether to begin the draft act 240 or the presentation act 250.

In the draft act 240, at step 615 and step 620, the audio tour controller block 134 displays the image and the address of the real estate property, respectively. At step 625, the audio tour controller block 134 allows the user to edit the image and/or address on the display 132. At step 630, the user can preview showcase of the edited image and/or edited address. After the preview, at step 635, the audio tour controller block 134 proceeds to publish the edited image and/or the edited address. At step 640, the audio tour controller block 134 enables the user to confirm whether to publish the edited image and/or the edited address or not. Upon the confirmation to publish, the audio tour controller block 134 publishes the image and/or the address, respectively.

As shown in FIG. 6, following the draft act 240, the presentation act 250 begins, where the audio tour controller block 134 allows/enables the user to edit the published image and/or address. Particularly, at step 650 and step 655, the image and the address are displayed, respectively. At step 660, the audio tour controller block 134 allows the user to edit the published image and/or address on the display. At step 665, the audio tour controller block 134 provides an option to view showcase of the published edited image and/or edited address. After the showcase, at step 670, the audio tour controller block 134 allows the user to share the edited image and/or the edited address through the share block 131.

Following the draft act 240 and/or the presentation act 250, the edit act 260 begins, which is explained in conjunction with FIG. 7. At step 710, the audio tour controller block 134 enables the user to select the photo gallery related to the real estate property. Upon selection, at step 720, the audio tour controller block 134 displays a grid of photos associated with the real estate property. At step 730, the user selects the photo from the photo gallery. Upon selection, at step 740, the audio tour controller block 134 enables the user to record the audio with the selected photo. At step 750, the user saves the selected photo with the audio and at step 760, the audio tour controller block 134 indicates the audio associated with the saved photo.

Following the edit act 260, the record act 270 begins, which is explained in conjunction with FIG. 8. At step 810, the audio tour controller block 134 navigates the selected photo to a recording studio panel. At step 820, the audio tour controller block 134 allows the user to record the audio with the selected photo. At step 830, the audio tour controller block 134 displays the recorded audio with the selected photo. The selected photo indicates a play button, a pause button, a stop button, a length of the audio, the timeline of the audio and delete audio information option.

Following the record act 270, the audio tour showcase act 280 begins, which is explained in conjunction with FIG. 9. At step 910, the audio tour controller block 134 fetches the photo for the audio tour. At step 920, the audio tour controller block 134 displays the fetched photo. At step 930, the audio tour controller block 134 enables the user to select the fetched photo to listen to the audio. At step 940, the audio tour controller block 134 playbacks/plays the audio.

FIG. 10 is a flow chart 1000 illustrating a method for providing the interactive virtual tour of the real estate property (“interactive virtual tour method 1000”). At step 1010, the real estate module 130 is triggered by the user of the interactive virtual tour system 100. At step 1020, the real estate module 130 displays the plurality of multimedia contents in response to triggering the real estate module 130. The plurality of multimedia contents is associated with the real estate property from the plurality of real estate properties. At step 1030, the user selects the multimedia content from the plurality of multimedia contents through the real estate module 130. At step 1040, the real estate module 130 plays the audio content associated with the selected multimedia content from the plurality of multimedia contents. The audio content elucidates the at least one feature of the real estate property. At step 1050, the real estate module 130 performs an action upon playing the audio content. The action can be, for example, but not limited to play back of the audio content, selection of at least one language from a plurality of languages to play the audio content, modification of an accent of the audio content, modification of a tone of the audio content, sharing of the audio content, and modification of an icon associated with the selected multimedia content.

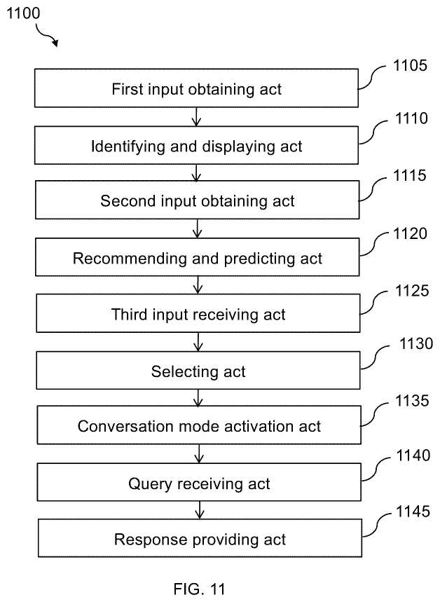

FIG. 11 is a flow chart 1100 illustrating a method for providing the interactive virtual tour of the real estate property for the buyer.

In a first input obtaining act 1105, the method includes obtaining the first input associated with the real estate property from the first user (e.g., buyer) to identify the real estate property from the plurality of real estate properties. The first input includes the preference, the historical transaction data, and the market trend (for example).

In an identifying and displaying act 1110, based on the first input, the method includes identifying and displaying the real estate property from the plurality of real estate properties using the data driven model.

Next, in a second input obtaining act 1115, the method includes obtaining the second input associated with the real estate property from the first user to fine-tune listing of the real estate property obtained after the first input. The second input includes the property preference, the budget constraint, and the location (for example).

In a recommending and predicting act 1120, based on the second input, the method includes recommending and predicting the real estate property from the plurality of real estate properties using the data driven model.

Next, in a third input receiving act 1125, the method includes receiving the third input to select the real estate property obtained after the second input.

In a selecting act 1130, the method includes selecting the real estate property from the plurality of real estate properties by the first user.

In a conversation mode activation act 1135, the method includes activating the conversation mode to enable the audio mode to explain the feature of the selected real estate property from the plurality of real estate properties.

Next, in a query receiving act 1140, the method includes receiving the query from the first user about the selected real estate property from the plurality of real estate properties.

In a response providing act 1145, the method includes providing the response about the selected real estate property to the first user based on the query. The response elucidates the feature of the real estate property.

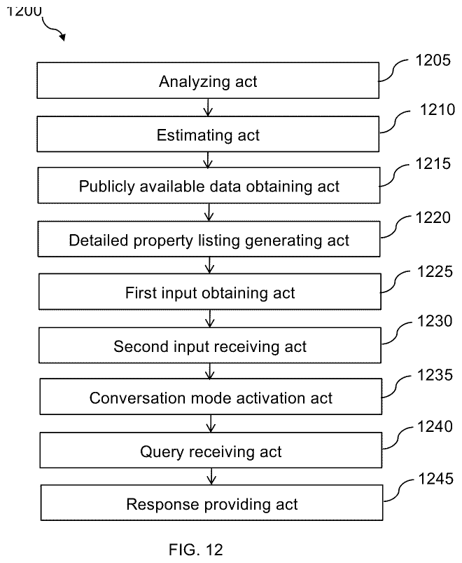

FIG. 12 is a flow chart 1200 illustrating a method for providing the interactive virtual tour of the real estate property for the seller.

In an analyzing act 1205, the method includes analyzing the market trend, the historical listing, and the property feature associated with the real estate property from the plurality of real estate properties, over a period of time, to determine the valuation and marketing strategy for the real estate property from the plurality of real estate properties.

In an estimating act 1210, the method includes estimating the market value for the real estate property from the plurality of real estate properties by analyzing each comparable real estate property, location-specific data, and property characteristics associated with the real estate property.

In a publicly available data obtaining act 1215, the method includes obtaining publicly available data including the image, the video, the map, the blueprint, the historical pricing, the population density, the crime rate, the square footage, the unique home feature, and the tax appraisal.

Next, in a detailed property listing generating act 1220, the method includes generating the detailed property listing for the real estate property from the plurality of real estate properties based on the valuation and marketing strategy, the estimated market value and the publicly available data.

In a first input obtaining act 1225, the method includes obtaining the first input associated with the real estate property from the second user (e.g., seller) to display the real estate property from the plurality of real estate properties. The first input includes the listing preference, the desired price range, and the marketing goal.

Next, in a second input receiving act 1230, the method includes receiving the second input from the first user (e.g., buyer) to select the real estate property from the plurality of real estate properties.

In a conversation mode activation act 1235, the method includes activating the conversation mode to enable the audio mode to explain the feature of the selected real estate property based on the second input.

In a query receiving act 1240, the method includes receiving the query about the selected real estate property.

Next, in a response providing act 1245, the method includes providing the response about the selected real estate property based on the query. The response elucidates the feature of the real estate property.

It may be noted that FIG. 2 through FIG. 12 are to be understood in conjunction with FIG. 1.

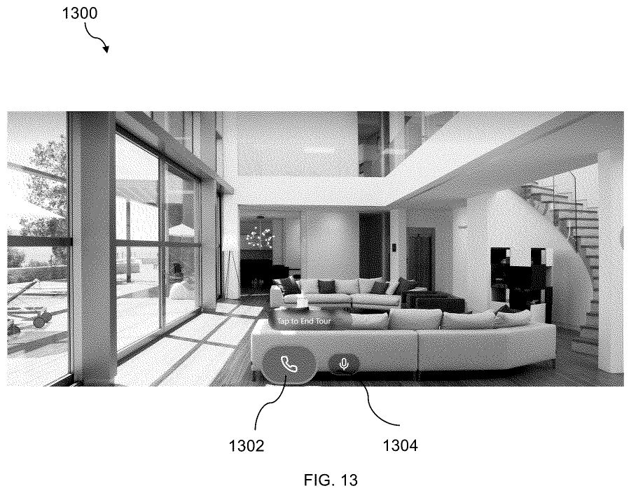

FIG. 13 is a screenshot 1300 depicting the interactive virtual tour of the real estate property. Consider an example where the seller/buyer initiates the conversation mode using a call button 1302 and asks about the hall details from the real estate module 130 using a microphone 1304. The interactive virtual tour of the property offers a fully immersive experience, enhanced by both visual and auditory elements to bring the space to life. As the buyer navigates through the spacious hall, they will be greeted by the soft, inviting sofa, perfectly placed for relaxation. The hall's design is both elegant and functional, with a set of steps adding dynamic flow to the building's layout. The response is provided in the form of audio through the microphone 1304.

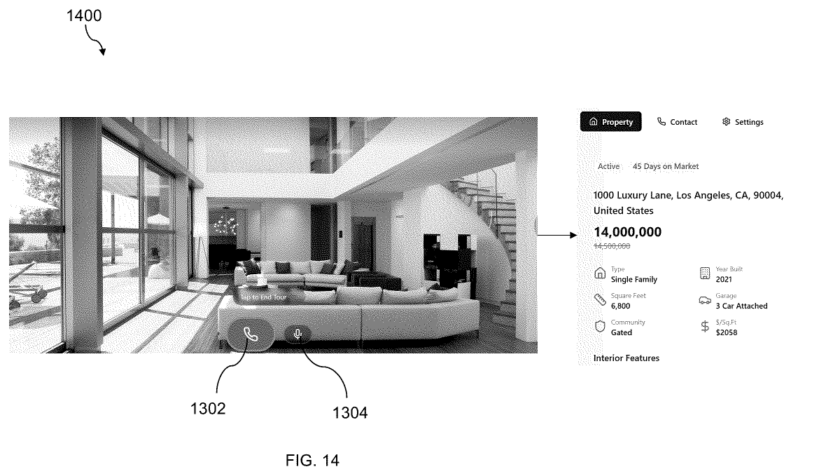

FIG. 14 is a screenshot 1400 depicting various features of the real estate property while providing the interactive virtual tour of the real estate property. Consider an example where the seller/buyer initiates the conversation mode using the call button 1302 and asks about the location and building details from the real estate module 130 through the microphone 1304. The real estate module 130 responds with, “the building is located at 1000 Luxury Lane, Los Angeles, CA, 90004, USA, and was built in 2021” in the form of audio through the microphone 1304.

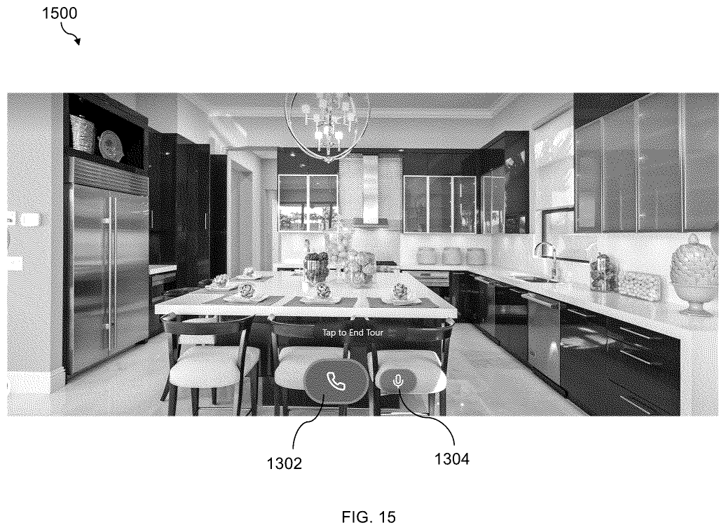

FIG. 15 is a screenshot 1500 depicting a feature associated with a kitchen while providing the interactive virtual tour of the real estate property. Consider an example where the seller/buyer initiates the conversation mode using the call button 1302 and asks about the feature associated with the kitchen using the microphone 1304. The real estate module 130 responds in the form of audio. In the response, as part of the interactive virtual tour of the real estate property, the system 100 highlights the kitchen area, which seamlessly integrates with a stylish dining space. The user can explore the modern kitchen, equipped with high-end appliances, sleek countertops, and ample storage. Adjacent to the kitchen is a spacious dining table, designed to comfortably seat twelve (for example), creating an ideal space for family meals or entertaining guests. As the virtual tour progresses, the system 100 provides auditory cues, such as the sound of utensils clinking and a soft background ambiance, enhancing the immersive experience of the kitchen and dining area. This feature allows the user to not only view the layout but also imagine the atmosphere and functionality of the space in everyday use.

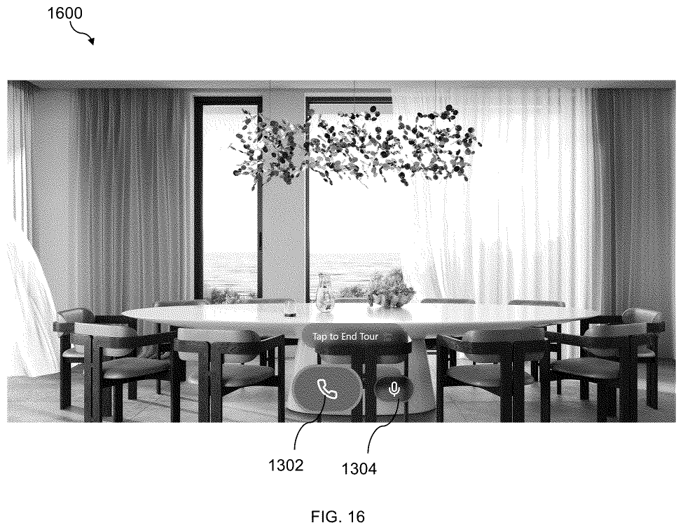

FIG. 16 is a screenshot 1600 depicting the feature associated with a dining hall and a decorative element while providing the interactive virtual tour of the real estate property.

Consider an example where the seller or the buyer initiates the conversation mode using the call button 1302 and asks about the feature associated with the dining hall and a decorative element using the microphone 1304. The real estate module 130 responds in the form of audio. In the response, as the user navigates through the interactive virtual tour of the real estate property, the system highlights the elegant dining hall, a central feature designed for both style and functionality. The dining hall is furnished with a beautiful, oversized dining table that comfortably seats eight, making it perfect for hosting gatherings or family dinners. The system also draws attention to the stunning decorative elements, such as a statement chandelier hanging above the table, casting a warm, inviting glow across the room. As the tour continues, subtle audio cues, like the soft clinking of glass and ambient background sounds, enhance the sense of realism, helping the user imagine the lively atmosphere of a dinner party. The virtual experience allows the user to fully appreciate the space's aesthetic appeal and its potential for entertaining.

The conversation mode, as mentioned above, may be ended by tapping the call button 1302 once the interactive virtual tour ends.

Although, the real estate module 130 is explained in view of the one or more broker(s) 111, the one or more owner(s) 112, the one or more authorized person(s) 113, the seller and the buyer however, the real estate module 130 is not limited to the one or more broker(s) 111, the one or more owner(s) 112, the one or more authorized person(s) 113, the seller and the buyer only and is also applicable to the other users as explained in conjunction with FIG. 1.

The various actions, acts, blocks, steps, or the like in the flow diagrams/charts 200, 210, 220, 230, 240, 250, 260, 270, 280, 600, 1000, 1100, and 1200 may be performed in the order presented, in a different order or simultaneously. Further, in some embodiments, some of the actions, acts, blocks, steps, or the like may be omitted, added, modified, skipped, or the like without departing from the scope of the present invention.

It may be noted that although the present invention shows various elements of the system 100, but it is to be understood that other alternatives are not limited thereon. Further, the labels or names of the elements/components are used only for illustrative purpose and do not limit the scope of the present invention. The shape and size of the various elements in the system 100 do not limit the scope of the present invention.

Unless otherwise defined, all technical and scientific terms used herein have the same meaning as commonly understood by one of ordinary skill in the art to which this invention belongs. Although methods and materials similar to or equivalent to those described herein can be used in the practice or testing of equivalent systems and methods, suitable systems and methods and are described above.

Although the invention has been described and illustrated with specific illustrative embodiments, it is not intended that the invention be limited to those illustrative embodiments. Those skilled in the art will recognize that variations and modifications can be made without departing from the spirit of the invention. Therefore, it is intended to include within the invention, all such variations and departures that fall within the scope of the appended claims and equivalents thereof.

What is claimed is:

1. A method for providing an interactive virtual tour of a real estate property, comprising:
obtaining, by a system, a first input associated with the real estate property from a first user to identify at least one real estate property from a plurality of real estate properties, wherein the first input comprises preference, historical transaction data, and market trend;
identifying and displaying, by the system, the at least one real estate property from the plurality of real estate properties based on the first input using a data driven model;
obtaining, by the system, a second input associated with the real estate property from the first user to fine-tune listing of the at least one real estate property obtained after the first input, wherein the second input comprises at least one property preference, budget constraint, and at least one location;
recommending and predicting, by the system, the at least one real estate property from the plurality of real estate properties based on the second input using the data driven model;
receiving, by the system, a third input to select the at least one real estate property obtained after the second input;
selecting, by the system, the at least one real estate property from the plurality of real estate properties by the first user;
activating, by the system, a conversation mode to enable an audio mode to explain at least one feature of the at least one selected real estate property from the plurality of real estate properties;
receiving, by the system, at least one query from the first user about the at least one selected real estate property from the plurality of real estate properties; and
providing, by the system, at least one response about the at least one selected real estate property to the first user based on the at least one query, wherein the at least one response elucidates at least one feature of the real estate property.

2. The method of claim 1, wherein the method comprises scheduling, by the system, a virtual tour for the at least one selected real estate property providing a three dimensional (3D) interactive tour in a preferred language of the first user.

3. The method of claim 1, wherein the at least one response describes at least one of an address, a location, longitude, latitude, a specific information, a landmark, type, size, and cost associated with the at least one selected real estate property.

4. The method of claim 1, wherein the at least one query comprises at least one of: a text query, an audio query and a gesture query, wherein the at least one response comprises an audio response, wherein the first user is a buyer.

5. The method of claim 1, wherein the method comprises:
selecting, by the system, at least one multimedia content from a plurality of multimedia contents associated with the at least one selected real estate property by the first user;
playing, by the system, an audio content associated with the at least one selected multimedia content from the plurality of multimedia contents; and
performing, by the system, at least one action upon playing the audio content, wherein the at least one action comprises play back of the audio content, selection of at least one language from a plurality of languages to play the audio content, modification of an accent of the audio content, modification of a tone of the audio content, sharing of the audio content, and modification of an icon associated with the at least one selected multimedia content.

6. The method of claim 1, wherein the method comprises:
generating and recommending, by the system, an offer for the at least one selected real estate property from the plurality of real estate properties.

7. The method of claim 6, wherein the method comprises:
receiving, by the system, a counter-offer for the at least one selected real estate property; and
generating and recommending, by the system, at least one of: a final offer and a pre-final offer for the at least one selected real estate property from the plurality of real estate properties.

8. The method of claim 1, wherein the method comprises:
determining, by the system, that at least two real estate properties from the plurality of real estate properties are selected by the first user;
tracking and visualizing, by the system, the at least two real estate properties from the plurality of real estate properties selected by the first user; and
comparing and recommending, by the system, at least one feature of the at least two real estate properties on a virtual offer grid interface.

9. The method of claim 8, wherein the method comprises:
providing, by the system, a score for the at least two real estate properties on the virtual offer grid interface.

10. The method of claim 1, wherein the method comprises:
obtaining, by the system, at least one of: a user preference, interaction data, and a feedback about the at least one real estate property over a period of time; and
providing, by the system, at least one personalized real estate property recommendation to the first user.

11. The method of claim 1, wherein the method comprises:
performing, by the system, at least one of:
verifying completeness and accuracy of at least one document associated with the at least one real estate property by cross-referencing at least one of: a local regulation requirement and a transaction requirement;
displaying the estimated real estate property cost, contingency associated with the at least one real estate property, and relative competitiveness of each property;
indicating a mortgage option and interest rate for the at least one real estate property;
identifying a common inspection issue for the at least one real estate property based on a property type and a location and coordinating a follow-up action for the at least one real estate property;
performing a predictive analytics to suggest an area with growth potential based on demographic data, economic data, and property value data.

12. A method for providing an interactive virtual tour of a real estate property, comprising:
analyzing, by a system, a market trend, a historical listing, and a property feature associated with at least one real estate property from a plurality of real estate properties, over a period of time, to determine a valuation and marketing strategy for the at least one real estate property from the plurality of real estate properties;
estimating, by the system, a market value for the at least one real estate property from the plurality of real estate properties by analyzing each comparable real estate property from the plurality of real estate properties, location-specific data, and property characteristics associated with the at least one real estate property from the plurality of real estate properties;
obtaining, by the system, publicly available data comprising at least one image, at least one video, at least one map, at least one blueprint, historical pricing, population density, a crime rate, a square footage, a unique home feature, and a tax appraisal;
generating, by the system, a detailed property listing for the at least one real estate property from the plurality of real estate properties based on the valuation and marketing strategy, the estimated market value and the publicly available data;
obtaining, by the system, a first input associated with the real estate property from a second user to display the at least one real estate property from the plurality of real estate properties, wherein the first input comprises a listing preference, a desired price range, and a marketing goal;
receiving, by the system, a second input from a first user to select the at least one real estate property from the plurality of real estate properties;
activating, by the system, a conversation mode to enable an audio mode to explain at least one feature of the at least one selected real estate property based on the second input;
receiving, by the system, at least one query about the at least one selected real estate property; and
providing, by the system, at least one response about the at least one selected real estate property based on the at least one query, wherein the at least one response elucidates at least one feature of the real estate property.

13. The method of claim 12, wherein the method comprises scheduling, by the system, a virtual tour for the at least one selected real estate property providing a three dimensional (3D) interactive tour in a preferred language of at least one of: the first user and the second user.

14. The method of claim 12, wherein the at least one response describes at least one of an address, a location, longitude, latitude, a specific information, a landmark, type, size, and cost associated with the at least one selected real estate property, wherein the at least one query comprises at least one of: a text query, an audio query and a gesture query, wherein the at least one response comprises an audio response, wherein the first user is a buyer and the second user is a seller.

15. The method of claim 12, wherein the method comprises:
selecting, by the system, at least one multimedia content from a plurality of multimedia contents associated with the at least one selected real estate property;
playing, by the system, an audio content associated with the at least one selected multimedia content from the plurality of multimedia contents; and
performing, by the system, at least one action upon playing the audio content, wherein the at least one action comprises play back of the audio content, selection of at least one language from a plurality of languages to play the audio content, modification of an accent of the audio content, modification of a tone of the audio content, sharing of the audio content, and modification of an icon associated with the at least one selected multimedia content.

16. The method of claim 12, wherein the method comprises:
generating and recommending, by the system, an offer for the at least one selected real estate property from the plurality of real estate properties;
receiving, by the system, a counter-offer for the at least one selected real estate property; and
generating and recommending, by the system, at least one of: a final offer and a pre-final offer for the at least one selected real estate property from the plurality of real estate properties.

17. The method of claim 12, wherein the method comprises:
obtaining, by the system, at least one of: a user preference, interaction data, and a feedback about the at least one real estate property over a period of time; and
sending, by the system, at least one personalized real estate property recommendation to the first user.

18. The method of claim 12, wherein the method comprises:
performing, by the system, at least one of:
verifying completeness and accuracy of at least one document associated with the at least one real estate property by cross-referencing at least one of: a local regulation requirement and a transaction requirement;
displaying the estimated real estate property cost, contingency associated with the at least one real estate property, and relative competitiveness of each property;
indicating a mortgage option and interest rate for the at least one real estate property;
identifying a common inspection issue for the at least one real estate property based on a property type and a location and coordinating a follow-up action for the at least one real estate property;
performing a predictive analytics to suggest an area with growth potential based on demographic data, economic data, and property value data;
displaying and ranking at least one received offer based on at least one parameter comprising offer amount, contingencies, and financing;
performing a targeted online marketing plan based on demographics and activity patterns of the first user;
updating a property pricing recommendation based on real-time data comprising the market value, seasonal trends, and buyer interest levels; and
evaluating a financial qualification and a successful transaction completion of a potential first user.

19. A system for providing an interactive virtual tour of a real estate property, comprising:
a memory;
a processor, coupled with the memory; and
a real estate module, coupled to the processor, configured to:
obtain a first input associated with the real estate property from a first user to identify at least one real estate property from a plurality of real estate properties, wherein the first input comprises preference, historical transaction data, and market trend;
identify and display the at least one real estate property from the plurality of real estate properties based on the first input using a data driven model;
obtain a second input associated with the real estate property from the first user to fine-tune listing of the at least one real estate property obtained after the first input, wherein the second input comprises at least one property preference, budget constraint, and at least one location;
recommend and predict the at least one real estate property from the plurality of real estate properties based on the second input using the data driven model;
receive a third input to select the at least one real estate property obtained after the second input;
select the at least one real estate property from the plurality of real estate properties by the first user;
activate a conversation mode to enable an audio mode to explain at least one feature of the at least one selected real estate property from the plurality of real estate properties;
receive at least one query from the first user about the at least one selected real estate property from the plurality of real estate properties; and
provide at least one response about the at least one selected real estate property to the first user based on the at least one query, wherein the at least one response elucidates at least one feature of the real estate property.
